(19) United States
(12) Patent Application Publication
(10) Pub. No.: US 2023/0214604 A1
(43) Pub. Date: Jul. 6, 2023

(54) TRANSLATING TECHNICAL OPERATING INSTRUCTION

(71) Applicant: PRIVACY4CARS, Inc., Kennesaw, GA (US)

(72) Inventor: Andrea Amico, Marietta, GA (US)

(21) Appl. No.: 17/569,923

(22) Filed: Jan. 6, 2022

(51) Int. Cl. G06F 40/58; G06F 40/51; G06F 40/47

(52) U.S. Cl. CPC G06F 40/58; G06F 40/51; G06F 40/47

(57) ABSTRACT

A method of translating instructions for operating electromechanical systems includes identifying an operating-language instruction from one or more operating-language instructions at least based on user information that includes a type of an electromechanical system and a desired operation. The method further includes determining whether one or more existing translated parameters are available to the computing device. The method also includes, in response to the one or more existing translated parameters being available to the computing device, identifying an existing translated parameter from among the one or more existing translated parameters at least based on a level of relevancy of the existing translated parameter to one or more user parameters, where the existing translated parameter has a highest level of relevancy to the one or more user parameters. The method also includes generating, by the computing device, a translated instruction from the operating-language instruction.

### TECHNICAL FIELD

The present disclosure relates generally to translations, and more particularly to translation of instructions for operating electromechanical systems.

### BACKGROUND

In some cases, manufacturers of electromechanical devices and systems (e.g., cars, television, tools) that sell such devices and systems in some countries and regions may provide operating manuals written in a language that is not typically used in the particular countries or regions. For example, a car manufacturer may sell a car in Poland but may not provide a manual written in Polish. Instead, the manufacturer may provide a manual that is written, for example, in English although a display screen of the car displays information in Polish (e.g., the system language of the car) that is also the user's language. In other case, electromechanical devices and systems that are originally sold in one country or region where a particular language is spoken may end up in another country or region that uses a different language. For example, a car initially sold in Spain may end up in Poland. In such cases, while the manual is written, for example, in English, the user's language (e.g., Polish) may be different even from the system language (e.g., Spanish) used to display information on the display screen of the car. In some cases, user may not be able to obtain a manufacturer provided user manual for a number of reasons. Furthermore, instructions for operating electromechanical systems are often not well suited to a simple natural language translation. This is not only because the language needed to offer instructions is technical in nature with structured sequences of very specific steps, but also because a natural language translation of specific steps (e.g., from English to Polish) may not match the actual language offered by the manufacturer of the device (e.g., on a input device such as a knob or a button or on an output device such as a screen or a printout). In fact, it is very common that different manufacturers of substantially similar systems may be offering different phrasing and translations of the substantially same instruction step for any given language. Thus, a solution that provides operating instructions for a user who speaks a different language than the language of the electromechanical system manual, and/or for a user that is operating an electromechanical system that is set in a language other than language spoken by the user or for which a manual is available may be desirable.

### SUMMARY

The present disclosure relates generally to translations, and more particularly to translation of instructions for operating electromechanical systems. In an example embodiment, a method of translating instructions for operating electromechanical systems includes identifying, by a computing device, an operating-language instruction from one or more operating-language instructions at least based on user information that includes a type of an electromechanical system and a desired operation, where the one or more operating-language instructions are in an operating language of the computing device and each include an operating-language action portion and an operating-language parameter. The method further includes determining, by the computing device, whether one or more existing translated parameters are available to the computing device, where the one or more existing translated parameters are translations of the operating-language parameter of the operating-language instruction that are in a system language of the electromechanical system. The method further includes, in response to the one or more existing translated parameters being available to the computing device, identifying, by the computing device, an existing translated parameter from among the one or more existing translated parameters at least based on a level of relevancy of the existing translated parameter to one or more user parameters contained in or determined based at least in part on the user information, where, from among the one or more existing translated parameters, the existing translated parameter has a highest level of relevancy to the one or more user parameters. The method further includes generating, by the computing device, a translated instruction from the operating-language instruction, where the translated instruction includes a translated action portion and the existing translated parameter if the one or more existing translated parameters are available to the computing device.

In another example embodiment, a system for translating instructions for operating electromechanical systems includes a computing device configured to identify an operating-language instruction from one or more operating-language instructions at least based on user information that includes a type of an electromechanical system and a desired operation, where the one or more operating-language instructions each include an operating-language action portion and an operating-language parameter. The computing device is further configured to determine whether one or more existing translated parameters that are in a system language of the electromechanical system are available to the computing device, where the one or more existing translated parameters are translations of the operating-language parameter of the operating-language instruction that are in a system language of the electromechanical system. The computing device is further configured to, in response to the one or more existing translated parameters being available to the computing device, identify an existing translated parameter from among the one or more existing translated parameters at least based on a level of relevancy of the existing translated parameter to user parameters contained in or determined based at least in part on the user information, where, from among the one or more existing translated parameters, the existing translated parameter has a highest level of relevancy to the user parameters. The computing device is further configured to generate a translated instruction from the operating-language instruction, where the translated instruction comprises the existing translated parameter if the one or more existing translated parameters are available to the computing device.

In another example embodiment, a non-transitory tangible computer-readable storage medium including executable instructions that are executable by a processor, the executable instructions include identifying an operating-language instruction from one or more operating-language instructions at least based on user information that includes a type of an electromechanical system and a desired operation, where the one or more operating-language instructions are in an operating language and the one or more operating-language instructions each include an operating-language action portion and an operating-language parameter. The executable instructions further include determining whether one or more existing translated parameters are available, where the one or more existing translated parameters are translations of the operating-language parameter of the operating-language instruction that are in a system language of the electromechanical system. The executable instructions further include, in response to the one or more existing translated parameters being available, identifying an existing translated parameter from among the one or more existing translated parameters at least based on a level of relevancy of the existing translated parameter to one or more user parameters contained in or determined based at least in part on the user information, where, from among the one or more existing translated parameters, the existing translated parameter has a highest level of relevancy to the one or more user parameters. The executable instructions further include generating a translated instruction from the operating-language instruction, where the translated instruction include a translated action portion and the existing translated parameter if the one or more existing translated parameters are available to the computing device.

These and other aspects, objects, features, and embodiments will be apparent from the following description and the appended claims.

### BRIEF DESCRIPTION OF THE FIGURES

Reference will now be made to the accompanying drawings, which are not necessarily drawn to scale, and wherein:

FIG. 1 illustrates a system for translating instructions for operating electromechanical systems according to an example embodiment;

FIG. 2 illustrates the dashboard of the vehicle shown in FIG. 1 according to an example embodiment;

FIG. 3 illustrates example operating-language instructions that are in an operating language of a main translation server according to an example embodiment;

FIG. 4 illustrates a user input page of the software application resident on the user device shown in FIG. 1 according to an example embodiment;

FIG. 5 illustrates an instruction page of the software application resident on the user device shown in FIG. 1 according to an example embodiment;

FIG. 6 illustrates another instruction page of the software application resident on the user device shown in FIG. 1 according to an example embodiment;

FIG. 7 illustrates a feedback page of the software application resident on the user device shown in FIG. 1 according to an example embodiment;

FIG. 8 illustrates the user input page of the software application resident on the user device shown in FIG. 1 according to an example embodiment;

FIG. 9 illustrates another instruction page of the software application resident on the user device shown in FIG. 1 according to an example embodiment;

FIG. 10 illustrates another instruction page of the software application resident on the user device shown in FIG. 1 according to an example embodiment;

FIG. 11 illustrates a feedback page of the software application resident on the user device shown in FIG. 1 according to an example embodiment; and

FIGS. 12A-12C illustrate a method of translating instructions for operating electromechanical systems according to an example embodiment.

The drawings illustrate only example embodiments and are therefore not to be considered limiting in scope. The elements and features shown in the drawings are not necessarily to scale, emphasis instead being placed upon clearly illustrating the principles of the example embodiments. Additionally, certain dimensions or placements may be exaggerated to help visually convey such principles. In the drawings, the same reference numerals used in different drawings may designate like or corresponding but not necessarily identical elements.

### DETAILED DESCRIPTION OF THE EXAMPLE EMBODIMENTS

In the following paragraphs, example embodiments will be described in further detail with reference to the figures. In the description, well known components, methods, and/or processing techniques are omitted or briefly described. Furthermore, reference to various feature(s) of the embodiments is not to suggest that all embodiments must include the referenced feature(s).

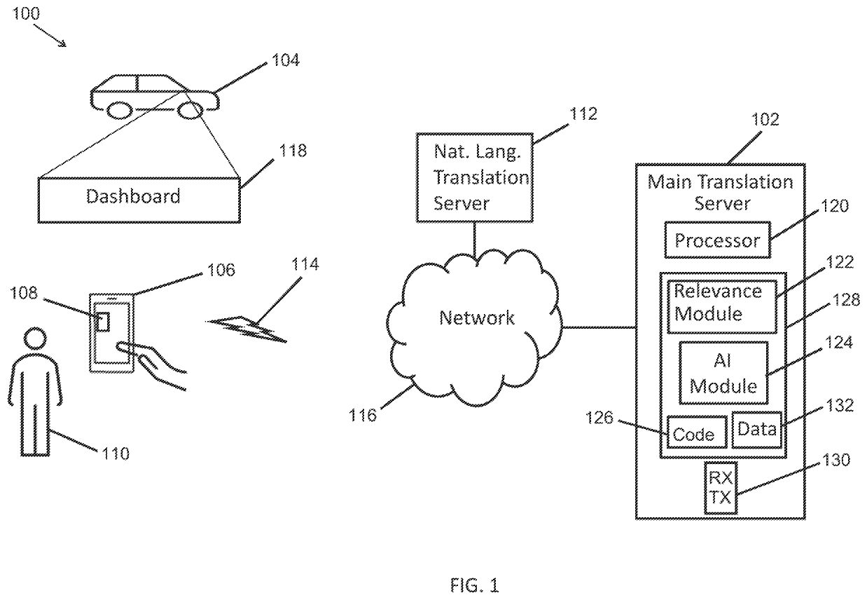

FIG. 1 illustrates a system 100 for translating instructions for operating electromechanical systems according to an example embodiment. In some example embodiments, the system 100 includes a main translation server 102 that operates as a computing device to translate instructions for operating a vehicle 104 or another electromechanical system. The system 100 may also include a user device 106 that may include a software application (“app”) 108. For example, the user device 106 may be a smartphone, a tablet, a laptop, a desktop, or another type of user device that can execute the app 108. A user 110 may use the app 108 on the user device 106 to request instructions from the main translation server 102 to operate the vehicle 104. In response to the request, the main translation server 102 may identify and/or generate translated instructions from operating-language instructions that are in the operating language (e.g., English) of the main translation server 102. The user device 106 may include a touchscreen and/or other input/output interfaces as can be readily understood by those of ordinary skill in the art. The user device 106 and the main translation server 102 may use the wireless signals 114 and/or other wireless or wired signals to communicate with each other. The wireless signals 114 may be compliant with one or more wireless communication standards. For example, the wireless signals 114 may be compliant with one or more of Wi-Fi, CDMA, GSM, etc.

In some example embodiments, the system 100 may include a natural language translation server 112 that provides natural language translations of terms. For example, the natural language translation server 112 may include a database similar to a standard dictionary where words are translated based on their ordinary use. As explained in more detail below, the main translation server 102 may communicate with the natural language translation server 112 to obtain natural language translations of terms. For example, the main translation server 102 may communicate with the natural language translation server 112 over a network 116. The network 116 may include a wired local network, a wireless local network, the internet, and/or other types of communication network. In some alternative embodiments, the natural language translation server 112 may be omitted, and natural language translation functions may be performed by the main translation server 102 or by another device or system without departing from the scope of this disclosure.

In some example embodiments, the vehicle 104 includes a dashboard 118 that is projected out in FIG. 1 for illustrative purposes. For example, the dashboard 118 may include one or more buttons, one or more knobs, one or more display screens that may be touchscreens, and/or other user input and/or output interfaces as can be readily understood by those of ordinary skill in the art. The dashboard 118 may include and/or display terms that are in a system language of the vehicle 104 that is different from the language in which the vehicle's user manual is available. System language as used herein refers to the language in which information is displayed on a display screen of the vehicle 104. In general, a display screen of the vehicle 104 displays information that can change, for example, based on user selection/input. In some cases, the dashboard 118 may include and/or display information in a system language understood by the user 110 (e.g., the system language of the vehicle 104 is the same as a user language). In other cases, the dashboard 118 may include and/or display information in a system language that is not understood by the user 110 (e.g., the system language of the vehicle 104 is different from a user language).

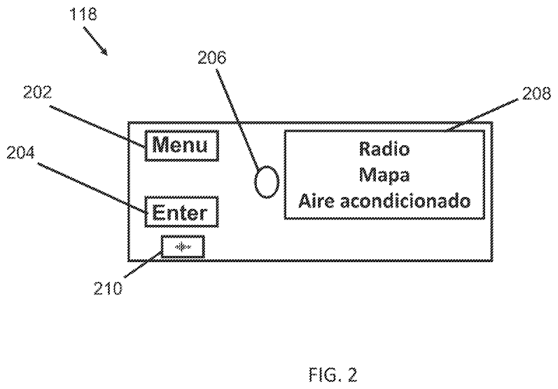

FIG. 2 illustrates the dashboard 118 of the vehicle shown in FIG. 1 according to an example embodiment. Referring to FIGS. 1 and 2, in some example embodiments, the dashboard 118 may include hardcoded input interfaces such as buttons, knobs, etc. that may include hardcoded terms. For example, the dashboard 118 may include a button 202 with the term Menu hardcoded thereon. As another example, the dashboard 118 may include a button 204 with the term Enter hardcoded thereon. As yet another example, the dashboard 118 may include a knob 206 without a term hardcoded thereon. As yet another example, the dashboard 118 may include a voice button 210 without a term hardcoded thereon.

In some example embodiments, the dashboard 118 may include a display screen 208. The display screen 208 may be a touchscreen or may be operated by the user 110 using the knob 206 or using other means as can be readily understood by those of ordinary skill in the art. The particular terms displayed on the display screen 208 may change depending on the information that the vehicle 104 wants to display on the display screen 208. As can be readily understood by those of ordinary skill in the art, the vehicle 104 may include a processor/controller that controls the operation of the display screen 208. In general, the vehicle 104 displays information on the display screen 208 in the system language of the vehicle 104. For example, as shown in FIG. 2, the system language of the vehicle may be Spanish. Because the manufacturer provided user manual of the vehicle 104 may be written for English speakers and the system language of the vehicle 104 may be Spanish or another language, such user manual may be inadequate for users (e.g., the user 110) whose language (e.g., the user language) is Spanish or another language (e.g., French) that is different from the manual's language.

Referring back to FIG. 1, in some example embodiments, the main translation server 102 may generate and provide instructions to the user 110 for use to operate or otherwise control some functions of the vehicle 104 using the dashboard 118. The main translation server 102 may include a processor 120, a memory device 128, and a communication unit 130 that may include one or more transmitters, one or more receivers, and/or one or more transceivers. For example, the processor 120 may include one or more microprocessors that execute software code stored in the memory device 128. The memory device 128 may include one or more non-transitory tangible computer readable storage medium. For example, the memory device 128 may include one or more memory devices (e.g., flash memory devices), one or more static random access memory (SRAM), one or more dynamic random access memory (DRAM) and/or other types of memory devices. The communication unit 130 may transmit and receive wired and/or wireless signals that are compliant with one or more communication standards such as Wi-Fi, Ethernet, etc.

In some example embodiments, a relevance module 122, an artificial intelligence module 124, other software code 126, and data 132 may be stored in the memory device 128. For example, the data 132 may include operating-language instructions for operating an electromechanical device or system such as the vehicle 104. The operating-language instructions can comprise textual content, audio content, or video images or other visual content that can be in an operating language (e.g., English) of the main translation server 102. The operating language of the main translation server 102 as used herein refers to the user interface language (e.g., English) used by the main translation server 102 to receive and send information from/to users and is not to be confused with the machine/computer language and/or format of the main translation server 102.

In some example embodiments, the operating-language instructions stored in the memory device 128 may be derived from one or more manuals provided by a manufacturer for operating the vehicle 104. Some other operating-language instructions in the memory device 128 may be derived from one or more manuals provided for operating other vehicles including vehicles that have various makes and models that are different from the make and model of the vehicle 104. To illustrate, operating-language instructions for performing various operations on the vehicle 104 and other vehicles may be stored as part of the data 132. Information defining sequences of operating-language instructions for performing individual operations/tasks on the vehicle 104 and other vehicles may be derived from the manuals and stored as part of the data 132. In some example embodiments, the processor 120 may execute the artificial intelligence module 124 to generate the operating-language instructions and sequences of the operating-language instructions from manufacturer manuals that generally describe operations in natural language expressions.

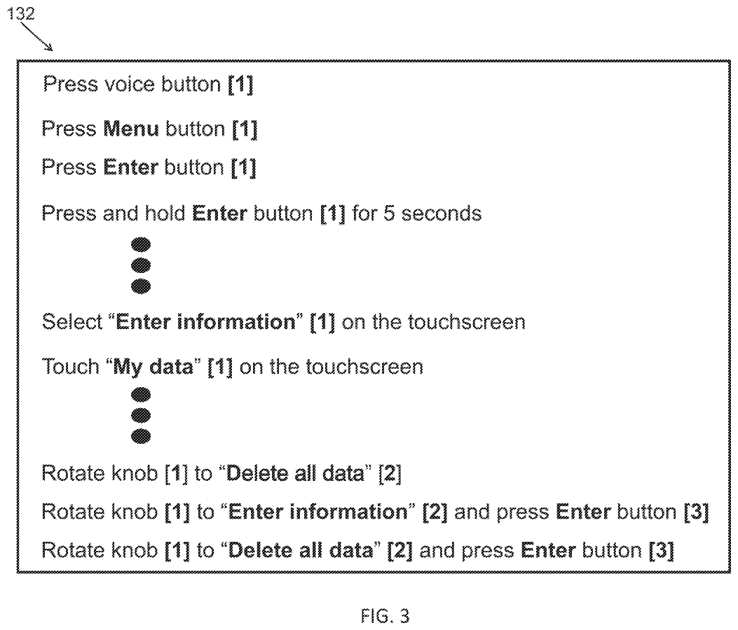

FIG. 3 illustrates example operating-language instructions that are in an operating language (e.g., English in this case) of the main translation server 102 shown in FIG. 1 according to an example embodiment. Referring to FIGS. 1-3, in some example embodiments, the operating-language instructions shown in FIG. 3 may be part of the data 132 stored in the memory device 128 shown in FIG. 1. To illustrate, an example of an operating-language instruction that may be stored in the memory device 128 is “Press voice button [1]”. The instruction is for a user to press a voice button such as the button 210 shown in FIG. 2. Such instructions may be identified in the memory device 128 as belonging to a particular type/category of instructions. In general, some operating-language instructions stored in the memory device 128 may be applicable to some types of vehicles but not others.

In some example embodiments, the number in the bracket (e.g., 1) is a label that is used to identify the dashboard element, “voice button,” in images associated with the operating-language instruction “Press voice button [1]”. To illustrate, an image or information that can be used to generate an image that shows elements (e.g., buttons, knobs, display screen, etc.) of the dashboard 118 of the vehicle 104 may be stored in the memory device 128, for example, in association with vehicle identifier information (e.g., the make and model) of the vehicle 104. For example, information indicating the elements (e.g., buttons, knobs, display screen) of the dashboard 118 in the image of the dashboard 118 may be stored in the memory device 128. Such information may be obtained, for example, from manufacturer provided manual(s), actual picture of the dashboard, etc. Information linking the label 1 in the operating-language instruction “Press voice button [1]” with the voice button 210 shown in the dashboard 118 may also be stored in the memory device 128. Because the operating-language instruction “Press voice button [1]” may be applicable to other vehicles that have different makes and models, the same or similar information, including image and/or image related information, as described above with respect to the vehicle 104 may be stored in the memory device 128 with respect to the operating-language instruction.

As another example, in some example embodiments, an operating-language instruction “Press Menu button [1]” may be stored in the memory device 128. The instruction is for a user to press button such as the button 202 shown in FIG. 2. In general, the operating-language instruction refers to a button with the English term, Menu, hardcoded thereon regardless of the system language of the vehicle 104. For example, a vehicle made in England and sold in Germany may include the button 202 (shown in FIG. 2) with the hardcoded term Menu although the system language of the vehicle may be German. Such instructions may be identified in the memory device 128 as belonging to another particular type/category of instructions.

In some example embodiments, information including dashboard image and/or image related information similar to that described above with respect to the operating-language instruction “Press voice button [1]” may be stored in the memory device 128 with respect to the operating-language instruction “Press Menu button [1]” and in association with vehicle identifier information (e.g., make and model) of the vehicle 104 and other vehicles. The operating-language instruction “Press voice button [1]” may be considered as a different type from the operating-language instruction “Press Menu button [1],” and information indicating the particular type of individual operating-language instructions may be stored in stored in the memory device 128.

As another example, in some example embodiments, an operating-language instruction “Select “Enter information” [1] on the touchscreen” may be stored in the memory device 128. For example, the particular operating-language instruction is related to the display screen 208 (e.g., the touchscreen) of the dashboard 118 of the vehicle 104. Operating-language instructions that are related to a display screen may be identified in the memory device 128 as belonging to another particular type/category of instructions. In general, such operating-language instructions have an operating-language action portion and an operating-language parameter portion. To illustrate with respect to the instruction “Select “Enter information” [1] on the touchscreen,” the term “Enter information” is the operating-language parameter and is associated with the label 1, and the remaining elements of the instruction are part of the operating-language action portion of the operating-language instruction. Another example of an operating-language instruction related to a display screen of a vehicle is “Touch ‘My data’ [1]” on the touchscreen” shown in FIG. 3, where the “My data” is the operating-language parameter of the instruction and is associated with the label 1 and where the remainder of the instruction is the action portion.

As another example, in some example embodiments, an operating-language instruction stored in the memory device 128 may include multiple instructions. For example, the multi-segment instruction “Rotate knob [1] to ‘Enter information’ [2] and press Enter button [3]” includes two instructions, e.g., “Rotate knob [1] to “‘Enter information’ [2]” and “press Enter button [3].” The first instruction, “Rotate knob [1] to ‘Enter information’ [2],” is related to the display screen even though the “knob” may be a physical element of a dashboard of a vehicle. The first instruction, “Rotate knob [1] to ‘Enter information’ [2],” includes the operating-language parameter “Enter information” associated with the label 2 that will be shown in an associated image, and the remaining elements of the first instruction are part of the action portion of the instruction. The second instruction “press Enter button [3]” in the multi-segment instruction refers to a hardcoded button such as the button 204 shown in FIG. 2.

In some example embodiments, translated instructions that are translated from the operating-language instructions may be stored in the memory device 128. The translated instructions can comprise textual content, audio content, or video images or other visual content. For example, the operating-language instruction “Press voice button [1]” may be translated once in its entirety into a translated instruction that is in a user language, and the translated instruction may be stored in the memory device 128 as a translation of the particular operating-language instruction. To illustrate, the translated instruction “Presione el botón de voz” may be stored as a translation of “Press voice button.” Translations of the operating-language instruction in multiple languages (e.g., Spanish, French, German, Polish, Russian, etc.) may be stored in the memory device 128. For such a type of operating-language instructions, the translated instructions may apply to different types of vehicles that are associated with the operating-language instructions. In some other examples, the translated instructions that are stored can be translated photos of screens of infotainment systems associated with the vehicle 104. The translated instructions can comprise subtitles for a video recording or a streaming video, e.g., a “how to” instructional.

As another example, the operating-language instruction “Press Enter button [3]” may be translated, where the terms “press” and “button” are translated to a user language but the hardcoded text “Enter” is maintained. The translated instruction that includes translated terms for “press” and “button” (for example, in Spanish) and the term “Enter” in English may be stored in the memory device 128 as a translation of the particular operating-language instruction. To illustrate, the translated instruction “Presiona Enter botón” may be stored as a translation of “Press Enter button.” Another example of instructions that include hardcoded text is “Press Menu button” and may have a corresponding translated instruction “Presiona Menu botón.” Translated instructions in multiple languages (e.g., Spanish, French, German, Polish, Russian, etc.) corresponding to such operating-language instruction (e.g., in English) may be stored in the memory device 128. For such a type of operating-language instructions, the translated instructions may apply to different types of vehicles that are associated with the operating-language instructions.

As described above, an operating-language instruction that is related to the display screen of a vehicle may include an operating-language action portion and an operating-language parameter. An example of such operating-language instructions is “Select ‘Enter information’ [1] on the touchscreen,” as described above. To illustrate, the example instruction is for a user to select “Enter information” on a display screen of the dashboard of a vehicle. Such an operating-language instruction may be associated with different types (e.g., makes, models, and years) of vehicles that may be made by the same or different manufacturers. That is, the operating-language instruction may be used by users of different types of vehicles that have the same system language (e.g., English) to perform the same operation. However, when the manufacturers make the vehicles for sale in another country (e.g., the vehicles have another system language (e.g., Spanish)), the same translation of the operating-language instruction from, for example, English to Spanish, may not be adequate for use with the different types of vehicles.

To illustrate, manufacturers that make vehicles for sale in another country may use different translations of the same terms that may be displayed on display screens of the vehicles. Indeed, even the same manufacturer may use varying translations of the same terms for display on display screens of vehicles. As such, for instructions, such operating-language instructions is “Select ‘Enter information’ [1] on the touchscreen,” that relate to display screens, although the operating-language action portion of the operating-language instruction can be translated into a translated action portion that is in a user language and may apply to different types of vehicles, the operating-language parameter of the operating-language instruction may need to be translated into different translated parameters in the system language(s) (e.g., Spanish, French, German, Polish, Russian, etc.) of the vehicles. For example, for some or all available operating-language instruction, the operating-language action portions of such operating-language instructions may be translated into translated action portions that are in one or more languages (e.g., Spanish, French, German, Polish, Russian, etc.) and stored in the memory device 128 for access by the processor 120 to generate translated instructions. To be clear, the system language of a vehicle and the user language of a user may be the same or different from each other.

In general, except for operating-language parameters and hardcoded terms described above, other terms in operating-language instructions are translated to the user language of the user 110. As described above, hardcoded terms are maintained in the operating-language of the main translation server 102, and operating-language parameters are translated to the system language of the vehicle 104. In general, operating-language instructions such as those shown in FIG. 3 may be in other languages, such as Spanish, German, French, etc. For example, if a French vehicle manufacturer provides vehicle manuals in French, operating-language instructions similar to the operation-language instructions shown in FIG. 3 but that are in French may be stored in the memory device 128, and French may be the operating language of the main translation server 102. To illustrate, the French operating-language instructions may be obtained from the operation manuals that generally use natural language expressions to describe operations. The main translation server 102 or another computing device may execute an artificial intelligence module, such as the artificial intelligence module 124 shown in FIG. 1, to generate the operation-language instructions that are in French.

Table 1 illustrates different translations of the operating-language parameter “Delete all data” associated with different types of vehicles and/or operating-language instructions. The Translated Parameter column in Table 1 shows existing translated parameters. Table 1 is illustrative of translation information that may be stored in the memory device 128 of the main translation server 102 for use in translating operating-language instructions when requested by users. In some example embodiments, some of the existing translated parameters may have been obtained from actual display screens of the respective vehicles or from other means including based on feedback information received from users.

TABLE 1

| | | | Operating-language | Translated |
|---|---|---|---|---|
| Row | Parameter | Type | Instruction | Parameter |
| 1 | Delete all | 2010 Ford | Rotate knob to | Borrar los |
| | data | Explorer | “Delete all data” | datos |
| | | XLT | | |
| 2 | Delete all | 2010 Ford | Touch “Delete all | Borrar todos |
| | data | Explorer | data” on the | los datos |
| | | XLT | touchscreen | |
| 3 | Delete all | 2008 Ford | Select “Delete all | Eliminar todos |
| | data | Explorer | data” on the | los datos |
| | | XLT | touchscreen | |
| 4 | Delete all | 2006 Mazda | Touch “Delete all | Eliminar los |
| | data | CX9 | data” | datos |
| 5 | Enter | 2010 Ford | Select “Enter | Introducir |
| | information | Explorer | information” on the | información |
| | | XLT | touchscreen | |
| 6 | My data | 2009 Toyota | Select “My data” on | Mis datos |
| | | Camry | the touchscreen | |

In general, the main translation server 102 may use translation information, such as the translation information shown in Table 1, stored in the memory device 128 to generate translated instructions that include one or more translated parameters. As stated above, the main translation server 102 may generate a translated instruction that includes terms in a system language and/or a user language in response to a request by a user.

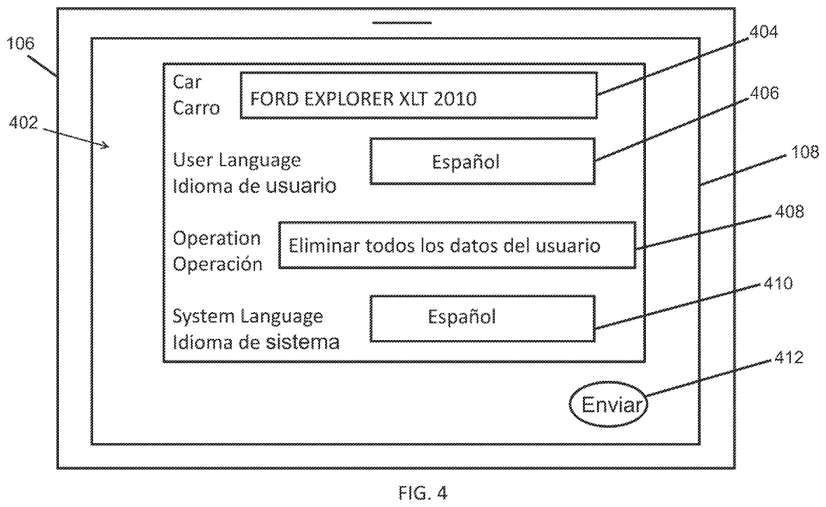

FIG. 4 illustrates a user input page 402 of the app 108 resident on the user device 106 shown in FIG. 1 according to an example embodiment. Referring to FIGS. 1-4, in some example embodiments, the user 110 may use the app 108 to request from the main translation server 102 instructions to perform operations on the vehicle 104. For example, the user input page 402 may include a vehicle type field 404, a user language field 406, a desired operation field 408, and a system language field 410. One or more of the fields 404-410 may be populated by selecting from a respective drop-down menu or by typing in the relevant information. Alternatively or in addition, the user input page 402 may include other means of populating the fields 404-410 including automatically populating some of the fields based on information previously provided to the app 108, information in the user's profile, etc. For example, the app 108 may determine the type of the vehicle 104 from the vehicle identification information (e.g., vehicle identification number (VIN)) of the vehicle 104. Alternatively or in addition, fields related to information already available to the app 108 may be omitted from the user input page 402. Alternatively or in addition, fields related to information available to the app 108 from a different source may be omitted from the user input page 402.

In some example embodiments, the vehicle type field 404 may be populated with information indicating the type of the vehicle 104 such as the make, model, and/or year of the vehicle 104. The user language field 406 may refer to the language understood by the user 110, and the system language field 410 may refer to the language used to display information on the display screen 208 of the vehicle 104. In the embodiment shown in FIG. 4, the user language and the system language are both indicated as being Spanish. The user 110 may indicate in the desired operation field 408 the operation that the user 110 wants to perform on the vehicle 104. For example, the app 108 may allow the user 110 to enter information in English, in the user language, or in another language.

In some example embodiments, the user 110 may indicate the operation that the user desires to perform on the vehicle 104. For example, as shown in FIG. 4, the user 110 may indicate in Spanish, which is the same as the user language, that the user 110 wants to delete all user data. The user 110 may then initiate the transmission of the user information entered in the fields 404-410, for example, by selecting the submit button 412, and in response, the user device 106 may transmit the user information to the main translation server 102. In some alternative embodiments, the user input page 402 may have other fields, fewer fields, different arrangements of the fields, different terms with respect to the fields, a different appearance, etc. without departing from the scope of this disclosure. In some example embodiments, some of the information provided by the user 110 to indicate the type of the vehicle 104 may be omitted without departing from the scope of this disclosure. Example, the specific model (e.g., XLT) may be omitted. In some alternative embodiments, the year may be omitted. In some alternative embodiments, additional information may be included to describe the type of the vehicle 104 without departing from the scope of this disclosure.

In some example embodiments, the main translation server 102 may have English as an operating-language, and upon receiving the user information, the main translation server 102 may identify an operating-language instruction or a sequence of operating-language instructions to be followed to perform the desired operation requested by the user 110. For example, the main translation server 102 may identify the operating-language instruction or the sequence of operating-language instructions from among operating-language instructions stored in the memory device 128. As described above with respect to FIG. 3, the data 132 stored in the memory device 128 may include operating-language instructions. Information associating different desired operations that may be requested by users with an operating-language instruction or a sequence of operating-language instructions may be stored in the memory device 128 with respect to different types of vehicles. Such information may be used to by the processor 120 to identify the particular operating-language instruction or sequence of operating-language instructions applicable to a desired operation requested by the user 110. To illustrate, the processor 120 of the main translation server 102 may identify the operating-language instruction or the sequence of operating-language instructions based on the type of the vehicle 104 and the desired operation indicated by the user information.

In some example embodiments, after identifying the operating-language instruction or the sequence of operating-language instructions applicable to the desired operation requested by the user 110, the processor 120 may generate one or more translated instructions based on the system language (e.g., Spanish) and the user language (e.g., Spanish) indicated by the user information. To illustrate, the processor 120 may determine that a sequence of operating-language instructions—“Press Menu button [1]” followed “Rotate knob [1] to ‘Delete all data’ [2] and press Enter button [3]”—is applicable to the desired operation requested by the user 110. Because the first operating-language instruction “Press Menu button [1]” in the sequence is related to a hardcoded button, e.g., the button 202 shown in FIG. 2, the processor 120 may obtain the translated instruction of the first operating-language instruction from the memory device 128. The translated instruction that is a translation of such operating-language instructions may be generated by the processor 120 and stored in the memory device 128 prior to the main translation server 102 receiving requests from the user 110.

In some example embodiments, the processor 120 may obtain from the memory device 128 the translated instruction for “press Enter button [3],” which is included in the second instruction of the sequence of operating-language instructions. To illustrate, the particular instruction is related to the hardcoded button 204 shown in FIG. 2.

In some example embodiments, the processor 120 may obtain the translated action portion of the operating-language instruction “Rotate knob [1] to ‘Delete all data’ [2]” from the memory device 128. The translated action portion of the instruction may include all terms in the instruction “Rotate knob [1] to ‘Delete all data’ [2]” except the operating-language parameter “Delete all data” and the labels 1, 2, and 3. For example, the knob in the operating-language instruction may apply to the knob 206 shown in FIG. 2.

In some example embodiments, the processor 120 may determine whether at least one existing translated parameter that is a translation of the operating-language parameter ‘Delete all data’ is available in the memory device 128. For example, Table 1 shows example existing translated parameters of the operating-language parameter “Delete all data” that may be stored in the memory device 128 with respect to different types of vehicles and operating-language instructions. Because Rows 1-4 of Table 1 are related to the operating-language parameter “Delete all data,” other rows of the Table 1 are not considered. After determining that one or more existing translated parameters corresponding to the operating-language parameter “Delete all data” are available, the processor 120 may determine a particular existing translated parameter from among the existing translated parameters that has a highest level of relevancy to user parameters that may be contained in or determined from the user information received from the user device 106. The processor 120 may execute the relevance module 122 to determine levels of relevancy of existing translated parameters to user parameters. For example, the user parameters may include the type of vehicle, e.g., Ford Explorer XLT 2010, and the operating-language instruction(s) determined by the processor 120 based on the desired operation indicated by the user information from the user device 106. In some alternative embodiments, the type of vehicle (e.g., make, model, and/or year) may be determined by the processor 120 from vehicle identification information (e.g., VIN) or other information that may be included in the user information received from the user 110.

In some example embodiments, the type of vehicle associated with existing translated parameters stored in the memory device 128 may have higher priority than other user parameters in determining the levels of relevancy of the existing translated parameters to the user parameters. The particular operating-language instruction associated with existing translated may be considered next in the hierarchy of priority in that order in determining the relevance of existing translated parameters to the user parameters. For example, because Rows 1 and 2 in Table 1 match the type of the vehicle 104 indicated in the user information received from the user 110, the existing translated parameters in the two rows are considered more relevant to the user parameters than the existing translated parameters in the other rows. Because the operating-language instruction in Row 1 matches the operating-language instruction determined from the user's desired request, the existing translated parameter “Borrar los datos” in Row 1 may be considered as having the highest relevance to the user parameters.

In some alternative embodiments, if the memory device 128 does not include Row 1, the existing translated parameter “Borrar todos los datos” that is in Row 2 of Table 1 may be considered as having the highest relevance to the user parameters based on a match in the type of the vehicle 104 as compared to other rows. In some alternative embodiments, if the memory device 128 does not include both Rows 1 and 2, the existing translated parameter “Eliminar todos los datos” in Row 3 of Table 1 may be considered as having the highest relevance to the user parameters based on a partial match with the type of the vehicle 104. In some alternative embodiments, if the memory device 128 does not include Rows 1, 2, and 3, the existing translated parameter “Eliminar todos los datos” that is in Row 3 of Table 1 may be considered as having the highest relevance to the user parameters based on a match with the operating-language parameter “Delete all data” although the type of vehicle and the operating-language instruction in Row 4 do not match the corresponding information in the user parameters contained in or generated from the user information received from the user device 106.

As can be readily understood by those of ordinary skill in the art with the benefit of this disclosure, in some alternative embodiments, criteria other than those described above may be implemented to identify an existing translated parameter that has the highest level of relevancy to user parameters without departing from the scope of this disclosure. For example, in some example embodiments, the operating-language instruction may be given higher priority than the type of vehicle in identifying an existing translated parameter that has the highest level of relevancy to user parameters. If only one existing translated parameter is available based on the operating-language instruction, the particular existing translated parameter may be selected as having the highest level of relevancy. If multiple existing translated parameters are available based on the operating-language instruction, the type of vehicle may be used to identify, from among the available ones, an existing translated parameter that has the highest level of relevancy.

In some example embodiments, if no existing translated parameter is available (e.g., an existing translated parameter that is considered a translation for the operating-language parameter “Delete all data” is not available in the memory device 128), the main translation server 102 may obtain a natural language translated parameter (e.g., in Spanish) of the operating-language parameter “Delete all data” from the natural language translation server 112. For example, the natural language translation server 112 may be a GOOGLE translation server. Alternatively, the main translation server 102 or another server may perform natural language translations.

In some example embodiments, some existing translated parameters that are stored in the memory device 128 may be considered (e.g., marked in the memory device 128) as unavailable with respect to particular types of vehicles and/or particular operating-language instructions that are obtained from the user information received from the user device 106. For example, if an existing translated parameter has been determined to be a poor or inadequate translation of an operating-language parameter with respect to a particular type of the vehicle 104 and/or a particular operating-language instruction, the relevance module 122 can designate the existing translated parameter as unavailable with respect to the particular type of vehicle and/or the particular operating-language instruction. For example, an existing translated parameter can be determined to be a poor or inadequate translation based at least in part on user feedback.

In some alternative embodiments, other information may also be considered in addition and/or instead of the type of vehicle and/or the operating-language instruction to determine the level of relevancy of existing translated parameters and to identify an existing translated parameter from among the existing translated parameters that has the highest level of relevancy. For example, engine type and/or other information that may not be clearly indicated by model and make information may be used. To illustrate, engine type and/or other information provided by the user 110 can be used to determine an existing translated parameters that has the highest level of relevancy if such information is also included in the memory device 128 in association with existing translated parameters.

In some example embodiments, after the existing translated parameter “Borrar los datos” in Row 1 is identified as having highest level of relevancy to user parameters, the processor 120 may generate the translated instruction of the second instruction “Rotate knob [1] to ‘Delete all data’ [2] and press Enter button [3]” that are in the sequence of identified operating-language instructions—“Press Menu button [1]” followed “Rotate knob [1] to ‘Delete all data’ [2] and press Enter button [3].” As described above, the action portions of such operating-language instructions may be translated to translated action portion that is in a user language (or multiple user languages) prior to the main translation server 102 receiving an instruction request/user information from the user 110, and the processor 120 may subsequently retrieve the translated action portion from the memory device 128 as needed. The main translation server 102 may send to the user device the translated instructions for the sequence of operating-language instructions identified by the processor 120. The main translation server 102 may send the translated instructions “Presiona Menu botón” and “Girar la perilla [1] a “Borrar los datos” [2] y presiona Enter botón [3]” along with respective images to the user device 106.

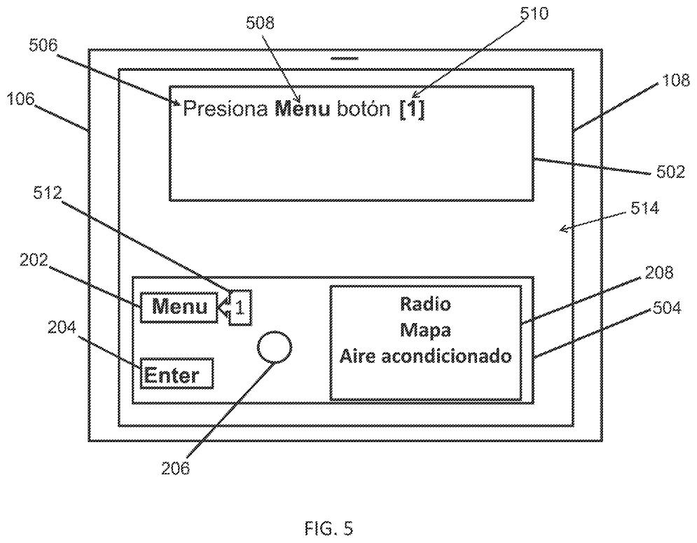

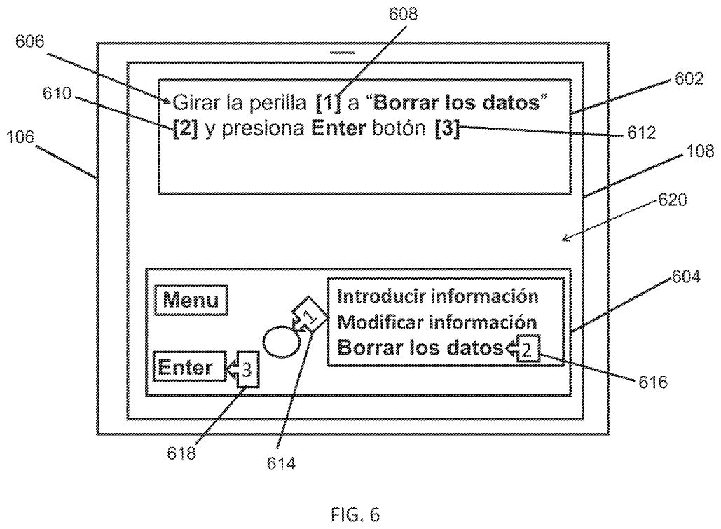

FIG. 5 illustrates an instruction page 514 of the app 108 resident on the user device 106 shown in FIG. 1 according to an example embodiment, and FIG. 6 illustrates another instruction page 620 of the of the app 108 according to an example embodiment. Referring to FIGS. 1-6, in some example embodiments, the user device 106 may receive the translated instructions from the main translation server 102, and the app 108 may display the instruction pages 514 and 620 on the user device 106. To illustrate, the instruction page 514 displays a translated instruction 506 (e.g., “Presiona Menu botón”) in a text portion 502 of the instruction page 514. As described above, the term Menu 508 in the translated instruction 506 refers to a term that is hardcoded on the hardware structure such as a button.

In some example embodiments, the app 108 may also display an image 504. The image 504 may be an actual image of the dashboard 118 of the vehicle 104 or a representative image of the dashboard 118. To illustrate, the image 504 shows the buttons 202, 204, the knob 206, and the display screen 208. When the image 504 is a representative image, the image 504 may be generated based on information indicating the elements (e.g., button(s), knob(s), display screen(s), etc.) of the dashboard 118. In general, actual images and information that can be used to generate the images of the dashboard 118 or portions thereof may be obtained from the manual(s) provided by the manufacturer of the vehicle 104.

In some example embodiments, label 1 510 in the text portion 502 and label 1 512 in the image 504 relate the “Menu boton” in the translated instruction 506 to the button 202 in the image 504. For example, the processor 120 may include the label 1 512 in an image of the dashboard 118 of the vehicle 104 to generate the image 504 as can be readily understood by those of ordinary skill in the art with the benefit of this disclosure. In some alternative embodiments, the label 1 510 may be omitted from the text portion 502 and/or the image 504 without departing from the scope of this disclosure. In some alternative embodiments, the image 504 may be omitted without departing from the scope of this disclosure.

In some example embodiments, the instruction page 620 of the of the app 108 shown in FIG. 6 may be displayed on the user device 106. For example, the user 110 may swipe the screen to move back and forth, for example, between the instruction page 514 and the instruction page 620. In the instruction page 620, the translated instruction 606 (e.g., “Girar la perilla [1] a “Borrar los datos” [2] y presiona Enter botón [3]”) is displayed in a text portion 602 of the instruction page 620. The translated instruction 606 is a translation of “Rotate knob [1] to ‘Delete all data’ [2] and press Enter button [3].” A label 1 608, a label 2 610, and a label 3 612 that are associated with different elements of the translated instruction 606 correspond, respectively, to a label 1 614, a label 2 616, and a label 3 618 shown in the image 604. The image 604 may be generated in the same or similar manner as described with respect to the image 504 shown in FIG. 5. The user 110 may follow the translated instructions 506, 606 to achieve the desired operation the user indicated in the user input page 402 shown in FIG. 4.

In some alternative embodiments, one or more of the labels 1 608, 2 610, and 3 612 may be omitted from the text portion 602 and/or the image 604 without departing from the scope of this disclosure. In some alternative embodiments, the image 604 may be omitted without departing from the scope of this disclosure.

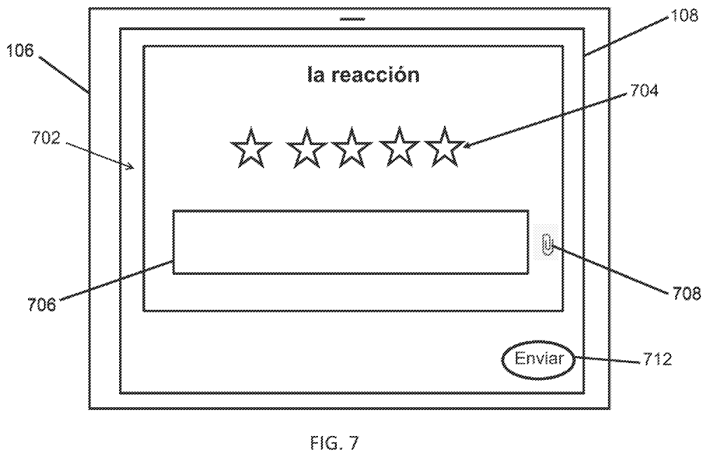

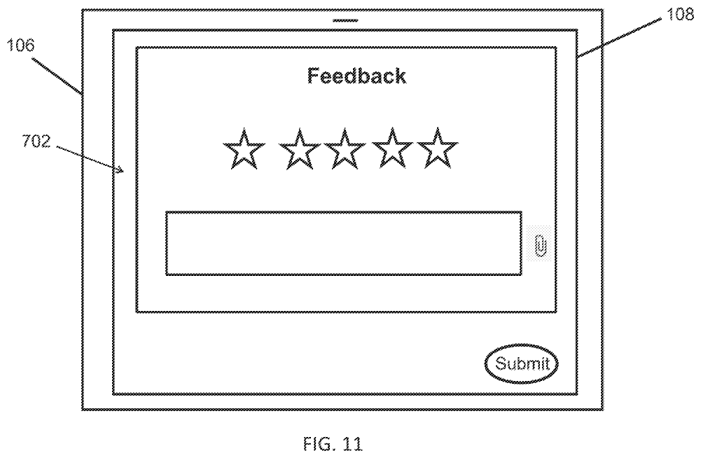

FIG. 7 illustrates a feedback page 702 of the app 108 resident on the user device 106 shown in FIG. 1 according to an example embodiment. Referring to FIGS. 1-7, in some example embodiments, the app 108 may provide the feedback page 702 for the user 110 to provide feedback related to the accuracy of the translated instructions 506, 606. For example, the user 110 may use a star rating system 704 to indicate the accuracy of the translated instructions 506, 606. Alternatively or in addition, the feedback page 702 may include a comment section 706 for the user 110 to provide written feedback. Alternatively or in addition, the feedback page 702 may include an attachment tag, and the user 110 may include an attachment (e.g., a picture, etc.) by selecting the attachment tag (e.g., the user interface element depicted as a paper clip in FIG. 11). The user device 106 may send the user's feedback information to the main translation server 102 upon the user 110 submitting the feedback, for example, by selecting a submit button 712. Because translated parameter(s) (e.g., “Borrar los datos”) of translated instructions can be the primary sources of inaccuracy of the translated instructions, in some example embodiments, the feedback provided by the user 110 may be considered as feedback on the translated parameter(s).

In some example embodiments, upon receiving the feedback information, the main translation server 102 may determine, from the feedback information, the accuracy level of the translated instructions provided to the user device 106, and particularly, the accuracy level of the translated parameter in the translated instructions indicated. To illustrate, the processor 120 of the main translation server 102 may determine from the feedback information from the user 110 the accuracy level of the translated parameter “Borrar los datos” as a translation of the operating-language parameter “Delete all data.” For example, if feedback(s) from the user 110 (or multiple users) indicate a low level of accuracy, the processor 120 may no longer use the translated parameter “Borrar los datos” as an existing translated parameter for the operating-language parameter “Delete all data” with respect to the particular type of the vehicle 104 and the particular operating-language instruction “Rotate Knob to ‘Delete all data’.”

In some example embodiments, if the main translation server 102 sends to the user device 106 a translated instruction that includes a natural language translated parameter and if the user 110 provides a feedback indicating high accuracy of the translated instruction using the feedback page 702, the processor 120 of the main translation server 102 may save the natural language translated parameter in the memory device 128 as an existing translated parameter with respect to the corresponding operating-language parameter. For example, such a natural language translated parameter may be stored as a new existing translated parameter with respect to the type of the vehicle 104 and the corresponding operating-language instruction in the same format shown in Table 1. In some example embodiments, multiple feedbacks indicating a high accuracy level may be received before a natural language translated parameter is saved as a new existing translated parameter. If one or more feedbacks indicate a natural language translated parameter has low accuracy level, the processor 120 stop using the natural language translated parameter.

In some example embodiments, the processor 120 may execute the artificial intelligence module 124 to analyze feedback information and to make determinations regarding continued use of a translated parameter, regardless of whether the translated parameter is obtained from the memory device 128 as an existing translated parameter or from a natural translation that is not yet designated as an existing translated parameter. To illustrate, the processor 120 may execute the artificial intelligence module 124 determine whether the received feedback information indicates that a translated instruction, such as the translated instruction 606, that includes a translated parameter meets an accuracy threshold. As a non-limiting example, an indication of at least four stars in the star rating system 704 may be required. In some alternative embodiments, in addition to or instead of the feedback page 702, users may provide feedback to the main translation server 102 using other means such as email without departing from the scope of this disclosure.

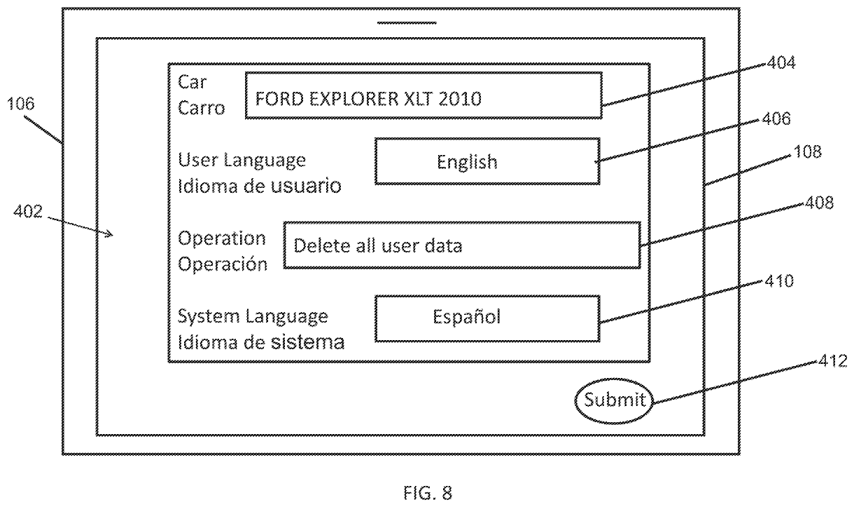

FIG. 8 illustrates the user input page 402 of the app 108 resident on the user device 106 shown in FIG. 1 according to an example embodiment. Referring to FIGS. 1-4 and 8, in some example embodiments, the user 110 may indicate in the user language field 406 that the user language is English as shown in FIG. 8. The user 110 may also indicate in the system language field 410 that Spanish as the system language of the vehicle 104 shown in FIG. 1. In some alternative embodiments, the user 110 may indicate the user language as another language (e.g., French, German, etc.) and the system language as the same or different from the user language.

The user 110 indicates the type of the vehicle 104 in the vehicle type field 404 as described above in FIG. 4. The user 110 may complete the desired operation field 408 by indicating the operation that the user 110 wants to perform on the vehicle 104. In contrast to FIG. 4, in FIG. 8, the user language is English instead of Spanish. After completing the information on the user input page 402, the user 110 may initiate the transmission of the user information (e.g., the information entered by the user 110 or obtained by the user device 106 based on such information) by selecting the submit button 412. In response, the user device 106 may transmit the user information to the main translation server 102.

In some example embodiments, the main translation server 102 may generate translated instructions based on the user information in a manner described above with respect to FIGS. 1-7. Because the user language indicated in FIG. 7 is English, which is different from Spanish indicated in FIG. 4, translated instructions generated by the main translation server 102 based on the user information in FIG. 7 include some terms in English. The main translation server 102 may send the translated instructions along with associated images to the user device 106 that may provide the translated instructions along with the images to the user 110.

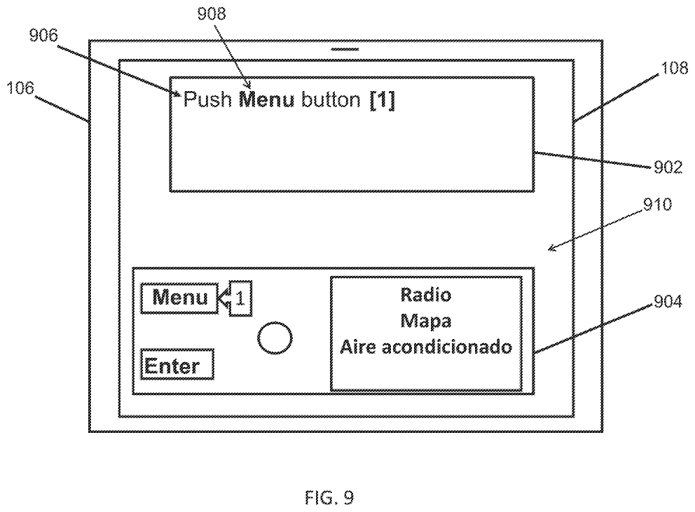

FIG. 9 illustrates an instruction page 910 of the app 108 resident on the user device 106 shown in FIG. 1 according to an example embodiment. The instruction page 910 displays a translated instruction 906 (e.g., “Push Menu button”) in a text portion 902 of the instruction page 910. Because the user language is English and the term Menu 908 is a hardcoded term, if the operating language of the main translation server 102 is also English, the translated instruction 906 may be effectively the same as the corresponding operating-language instruction identified by the main translation server 102 as described above. If the operating language of the main translation server 102 is not English (e.g., French or German), the terms “push” and “button” would have translated from an operating-language instruction that is in another language in the same manner as described above with respect to FIGS. 1-7 when the operating language is English.

In some example embodiments, an image 904 that may be generated in the same manner as described with respect to the image 504 shown in FIG. 5 may be included in the instruction page 910. One or more corresponding labels may be shown with respect to the language instruction in the text portion 902 and in the image 904 in the same manner as described above with respect to FIG. 5.

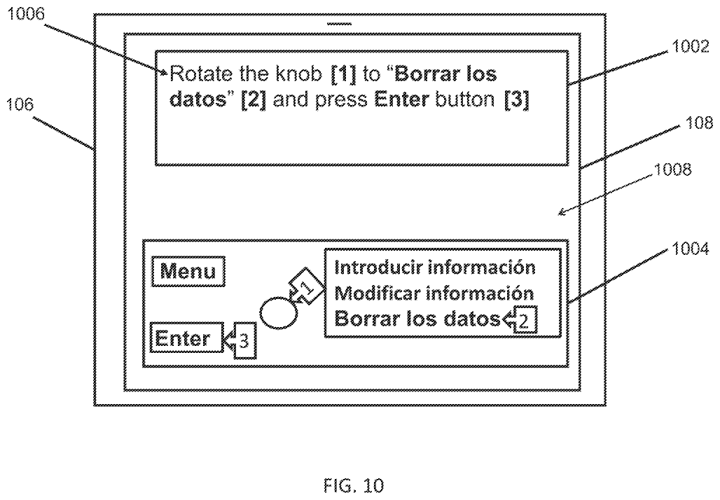

FIG. 10 illustrates another instruction page 1008 of the app 108 resident on the user device 106 shown in FIG. 1 according to an example embodiment. In some example embodiments, a translated instruction 1006 (e.g., “Rotate the knob [1] to “Borrar los datos” [2] y press Enter button [3]”), which is a translation of the operating-language instruction “Rotate knob [1] to ‘Delete all data’ [2] and press Enter button [3],” is displayed in a text portion 1002 of the instruction page 1008. Because the user language indicated by the user 110 is English, terms of the translated instruction 1006 other than the translated parameter “Borrar los datos” are in English as shown in FIG. 10. The translated parameter “Borrar los datos” may be determined by the main translation server 102 in the same manner as described with respect to FIGS. 1-7.

In some example embodiments, an image 1004 that may be generated in the same manner as described with respect to the image 604 shown in FIG. 6 may be included in the instruction page 1008. One or more corresponding labels may be shown with respect to the translated instruction 1006 in the text portion 1002 and in the image 1004 in the same manner as described above with respect to FIG. 6.

FIG. 11 illustrates the feedback page 702 of the app 108 resident on the user device 106 shown in FIG. 1 according to an example embodiment. In general, the feedback page 702 shown in FIG. 11 may be used in the same manner as described above with respect to FIG. 7. The main translation server 102 may process and use the feedback information received via the feedback page 702 to update (e.g., add, remove, etc.), in needed, existing translated parameters.

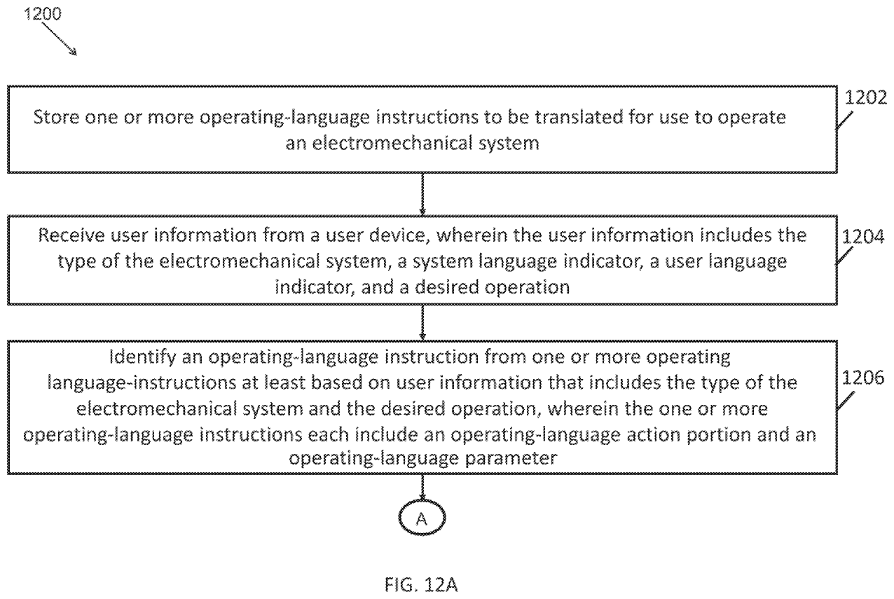

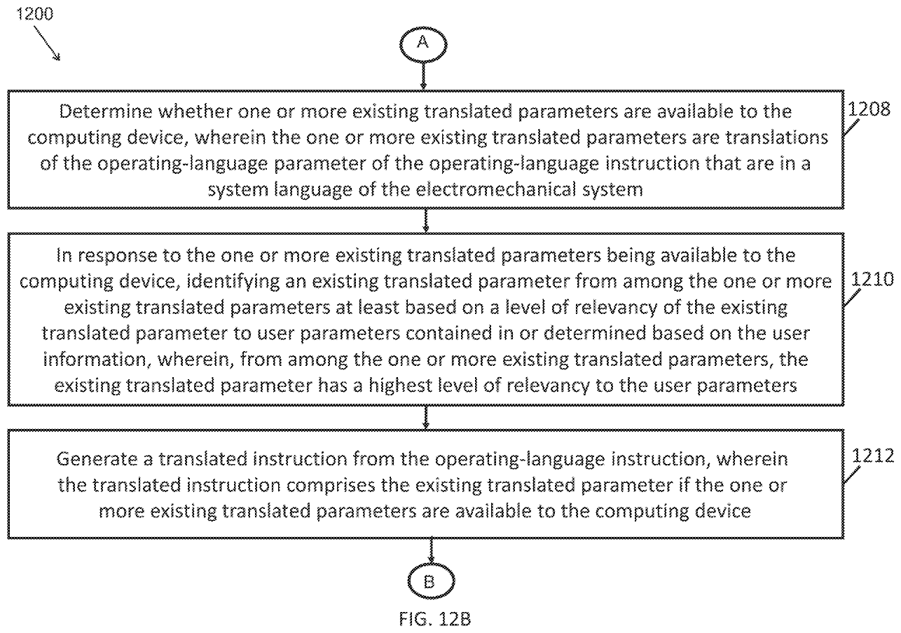

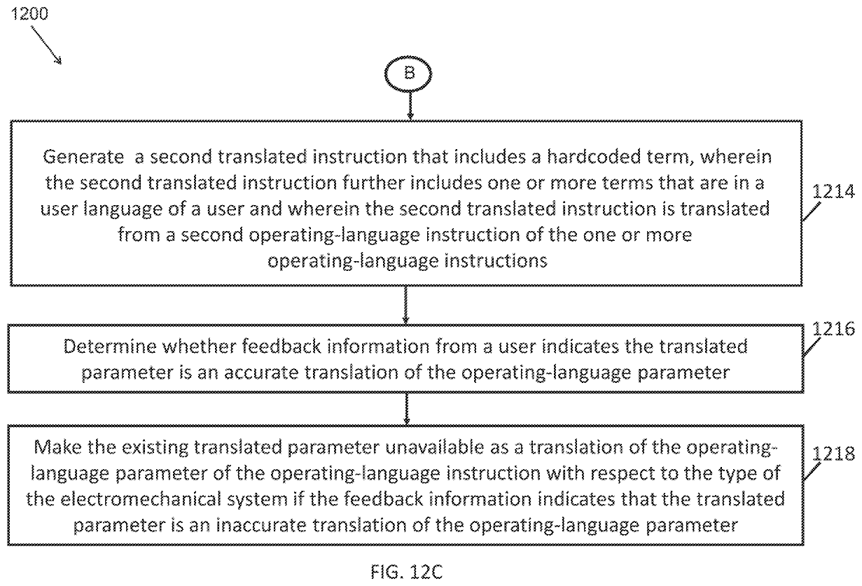

FIGS. 12A-12C illustrate a method 1200 of translating instructions for operating electromechanical systems according to an example embodiment. Referring to FIGS. 1-12C, in some example embodiments, at step 1202, the method 1200 includes storing, by a computing device (e.g., the main translation server 102), one or more operating-language instructions (.e.g., operating-language instructions shown in FIG. 3) to be translated for use to operate an electromechanical system (e.g., the vehicle 104 shown in FIG. 1). At step 1204, the method 1200 may include receiving user information (e.g., user information provided by the user 110 via the user input page 402 shown in FIG. 4) from a user device (e.g., the user device 106). The user information may include the type of the electromechanical system (e.g., the type of the vehicle 104), a system language indicator, a user language indicator, and a desired operation (e.g., delete all user data, enter phone number, adjust clock, etc.).

In some example embodiments, at step 1206, the method 1200 may include identifying an operating-language instruction from one or more operating language instructions at least based on user information that includes the type of the electromechanical system (e.g., the make, model, and year of the vehicle 104) and the desired operation. For example, an operating-language instruction from among the operating-language instructions stored in the memory device 128 as shown in FIG. 3 may be identified. As described above with respect to FIG. 3, the operating-language instructions may each include an operating-language action portion and an operating-language parameter.

In some example embodiments, continuing with FIG. 12B as indicated by the off-page connector A, the method 1200 may include, at step 1208, determining, by the computing device (e.g., the main translation server 102), whether the one or more existing translated parameters are available to the computing device, where the one or more existing translated parameters are translations of the operating-language parameter of the operating-language instruction that are in a system language of the electromechanical system. For example, the main translation server 102 may determine whether the translated parameters, such as those in shown in the Translated Parameter column of Table 1 above, are available in the memory device 128 for use by the main translation server 102.

In some example embodiments, at step 1210, the method 1200 may include, in response to the one or more existing translated parameters being available to the computing device, identifying an existing translated parameter (e.g., “Borrar los datos” in Table 1) from among the one or more existing translated parameters at least based on a level of relevancy of the existing translated parameter to user parameters (e.g., the type of the vehicle 104 and the operating-language instruction identified in step 1206) contained in or determined based on the user information from the user 110. From among the one or more existing translated parameters, the existing translated parameter may have a highest level of relevancy to the user parameters as described with respect to FIG. 4 and Table 1.

In some example embodiments, at step 1212, the method 1200 may include generating a translated instruction (e.g., “Rotate the knob to ‘Borrar los datos’”) from the operating-language instruction. The translated instruction includes the existing translated parameter (e.g., “Borrar los datos”) if the one or more existing translated parameters, such as those shown in Table 1, are available to the computing device.

In some example embodiments, continuing with FIG. 12C as indicated by the off-page connector B, the method 1200 may include, at step 1214, generating, by the computing device, a second translated instruction (e.g., “Presiona Enter botón”) that includes a hardcoded term (e.g., Enter). The second translated instruction further includes one or more terms (e.g., “Presiona” and “botón”) that are in a user language (e.g., Spanish) of a user (e.g., the user 110). The second translated instruction is translated from a second operating-language instruction (e.g., “Press Enter button”) of the one or more operating-language instructions, such as those shown in FIG. 3.

In some example embodiments, the method 1200 may include, at step 1216, determining whether feedback information from a user (e.g., the user 110) indicates the translated parameter is an accurate translation of the operating-language parameter (e.g., “Borrar los datos”). At step 1218, the method 1200 may include making the existing translated parameter unavailable as a translation of the operating-language parameter (e.g., “Borrar los datos”) of the operating-language instruction (e.g., “Delete all data”) with respect to the type of the electromechanical system (e.g., the type of the vehicle 104) if the feedback information indicates that the translated parameter is an inaccurate translation of the operating-language parameter.

In some example embodiments, instead of the operating-language parameter (e.g., “Borrar los datos”), the translated instruction generated by the computing device (e.g., the main translation server 102) may include a natural language translated parameter of the operating-language parameter (e.g., “Delete all data”) of the operating-language instruction. For example, the natural language translated parameter may be generated if the one or more existing translated parameters (e.g., existing translated parameters shown in Table 1) are unavailable to the computing device. The method 1200 may include storing the natural language translated parameter as a new existing translated parameter in association with the type of the electromechanical system (e.g., the vehicle) if feedback information received from a user (e.g., the user 110 via the user device 106) indicates the natural language translated parameter is an accurate translation of the operating-language parameter.

In some alternative embodiments, the method 1200 may include more or fewer steps than shown without departing from the scope of this disclosure. In some alternative embodiments, the steps of the method 1200 may be performed in a different order than shown without departing from the scope of this disclosure. In some example embodiments, the computing device described with respect to the method 1200 may be the main translation server 102, the user device 106 that has relevant capabilities of the main translation server 102, the vehicle 104, where relevant capabilities of the main translation server 102 and the user device 106 are integrated therein, or another device without departing from the scope of this disclosure.

Referring to FIGS. 1-12C, by generating operating-language instructions from manuals and by providing translated instructions as described above, the methods and systems described herein can provide operating instructions to users that do not have access to manuals in the users' languages. By updating the available translated parameters for use in translated instructions, the methods and systems can continuously increase the accuracy of translated instructions.

In some alternative embodiments, the components and/or operations described with respect to the user device 106 may be integrated in the vehicle 104, in another vehicle, or in another type of electromechanical device or system, such as factory equipment, a television, a smartphone, etc. In some alternative embodiments, the components and/or operations described with respect to the main translation server 102 may be integrated in the user device 106. In some alternative embodiments, the components and/or operations described with respect to the main translation server 102 and with respect to the user device 106 may be integrated in the vehicle 104, in another vehicle, or in another type of electromechanical device or system. In some alternative embodiments, some of the information described herein as being stored in the memory device 128 may be stored in another device, internal or external to the main translation server 102, and may be accessible by the main translation server 102 without departing from the scope of this disclosure. In general, information displayed on the user device 106 as shown in the figures may appear differently than shown without departing from the scope of this disclosure. In general, the descriptions provided herein with respect to the vehicle 104 may be applicable to electromechanical devices and systems other than vehicles and to information (e.g., type) applicable to such other electromechanical devices and systems.

Although particular embodiments have been described herein in detail, the descriptions are by way of example. The features of the example embodiments described herein are representative and, in alternative embodiments, certain features, elements, and/or steps may be added or omitted. Additionally, modifications to aspects of the example embodiments described herein may be made by those skilled in the art without departing from the scope of the following claims, the scope of which are to be accorded the broadest interpretation so as to encompass modifications and equivalent structures.

What is claimed is:

1. A method of translating instructions for operating electromechanical systems, the method comprising:
identifying, by a computing device, an operating-language instruction from one or more operating-language instructions at least based on user information that includes a type of an electromechanical system and a desired operation, wherein the one or more operating-language instructions are in an operating language of the computing device and each include an operating-language action portion and an operating-language parameter;
determining, by the computing device, whether one or more existing translated parameters are available to the computing device, wherein the one or more existing translated parameters are translations of the operating-language parameter of the operating-language instruction that are in a system language of the electromechanical system;
in response to the one or more existing translated parameters being available to the computing device, identifying, by the computing device, an existing translated parameter from among the one or more existing translated parameters at least based on a level of relevancy of the existing translated parameter to one or more user parameters contained in or determined based at least in part on the user information, wherein, from among the one or more existing translated parameters, the existing translated parameter has a highest level of relevancy to the one or more user parameters; and
generating, by the computing device, a translated instruction from the operating-language instruction, wherein the translated instruction comprises:
a translated action portion; and
the existing translated parameter if the one or more existing translated parameters are available to the computing device.

2. The method of claim 1, wherein the translated instruction comprises a natural language translated parameter of the operating-language parameter of the operating-language instruction that is generated if the one or more existing translated parameters are unavailable to the computing device.

3. The method of claim 2, further comprising storing the natural language translated parameter as a new existing translated parameter in association with the type of the electromechanical system if feedback information indicates the natural language translated parameter is an accurate translation of the operating-language parameter.

4. The method of claim 2, wherein one or more levels of relevancy of the one or more existing translated parameters to the one or more user parameters are determined at least based on the type of the electromechanical system included in the user information and one or more stored types of the electromechanical system associated with the one or more existing translated parameters.

5. The method of claim 4, wherein the one or more levels of relevancy of the one or more existing translated parameters are determined further based at least in part on the operating-language instruction and one or more stored operating-language instructions associated with the one or more existing translated parameters.

6. The method of claim 4, further comprising:
determining, by the computing device, whether feedback information indicates the translated parameter is an accurate translation of the operating-language parameter; and
making, by the computing device, the existing translated parameter unavailable as a translation of the operating-language parameter of the operating-language instruction with respect to the type of the electromechanical system if the feedback information indicates that the translated parameter is an inaccurate translation of the operating-language parameter.

7. The method of claim 1, wherein the user information further includes a system language indicator that indicates the system language of the electromechanical system and a user language indicator that indicates a user language of a user device that receives the translated instruction.

8. The method of claim 1, further comprising generating, by the computing device, the one or more operating-language instructions from natural language instructions.

9. The method of claim 1, wherein the translated instruction includes the operating-language action portion of the operating-language instruction or a translated action portion that is in a user language of a user device and wherein the translated action portion is translated from the operating-language action portion of the operating-language instruction.

10. The method of claim 1, further comprising generating, by the computing device, a second translated instruction that includes a hardcoded term, wherein the second translated instruction further includes one or more terms that are in a user language of a user device and wherein the second translated instruction is translated from a second operating-language instruction of the one or more operating-language instructions.

11. The method of claim 10, wherein the translated instruction is translated from the operating-language action portion of the second operating-language instruction and stored in a storage unit accessible by the computing device prior to the computing device receiving the user information from the user device.

12. The method of claim 1, wherein the translated parameter in the translated instruction is included in an image received from the computing device.

13. The method of claim 12, wherein the translated instruction includes a label associated with the translated parameter and wherein the label is shown in the image in association with the translated parameter shown in the image.

14. The method of claim 1, further comprising receiving, by the computing device, the user information from a user device.

15. A system for translating instructions for operating electromechanical systems, the system comprising a computing device configured to:
identify an operating-language instruction from one or more operating-language instructions at least based on user information that includes a type of an electromechanical system and a desired operation, wherein the one or more operating-language instructions each include an operating-language action portion and an operating-language parameter;
determine whether one or more existing translated parameters that are in a system language of the electromechanical system are available to the computing device, wherein the one or more existing translated parameters are translations of the operating-language parameter of the operating-language instruction that are in the system language of the electromechanical system;
in response to the one or more existing translated parameters being available to the computing device, identify an existing translated parameter from among the one or more existing translated parameters at least based on a level of relevancy of the existing translated parameter to user parameters contained in or determined based at least in part on the user information, wherein, from among the one or more existing translated parameters, the existing translated parameter has a highest level of relevancy to the user parameters; and
generate a translated instruction from the operating-language instruction, wherein the translated instruction comprises the existing translated parameter if the one or more existing translated parameters are available to the computing device.

16. The system of claim 15, wherein the translated instruction comprises a natural language translated parameter of the operating-language parameter of the operating-language instruction that is generated if the one or more existing translated parameters are unavailable to the computing device.

17. The system of claim 15, wherein one or more levels of relevancy of the one or more existing translated parameters to the user parameters are determined at least based on the type of the electromechanical system included in the user information and one or more stored types of the electromechanical system associated with the one or more existing translated parameters.

18. The system of claim 15, wherein the computing device further configured to
determine whether feedback information indicates the translated parameter is an accurate translation of the operating-language parameter; and
make the existing translated parameter unavailable as a translation of the operating-language parameter of the operating-language instruction with respect to the type of the electromechanical system if the feedback information indicates that the translated parameter is an inaccurate translation of the operating-language parameter.

19. A non-transitory tangible computer-readable storage medium comprising instructions that are executable by a computing device comprising a processor, the instructions comprising:
identifying an operating-language instruction from one or more operating-language instructions at least based on user information that includes a type of an electromechanical system and a desired operation, wherein the one or more operating-language instructions are in an operating language and the one or more operating-language instructions each include an operating-language action portion and an operating-language parameter;
determining whether one or more existing translated parameters are available, wherein the one or more existing translated parameters are translations of the operating-language parameter of the operating-language instruction that are in a system language of the electromechanical system;
in response to the one or more existing translated parameters being available, identifying an existing translated parameter from among the one or more existing translated parameters at least based on a level of relevancy of the existing translated parameter to one or more user parameters contained in or determined based at least in part on the user information, wherein, from among the one or more existing translated parameters, the existing translated parameter has a highest level of relevancy to the one or more user parameters; and
generating a translated instruction from the operating-language instruction, wherein the translated instruction comprises:
a translated action portion; and
the existing translated parameter if the one or more existing translated parameters are available to the computing device.

20. The non-transitory tangible computer-readable storage medium of claim 19, wherein the translated instruction comprises a natural language translated parameter of the operating-language parameter of the operating-language instruction that is generated if the one or more existing translated parameters are unavailable to the computing device.
